(19) United States
(12) Patent Application Publication
(10) Pub. No.: US 2021/0305701 A1
(43) Pub. Date: Sep. 30, 2021

(54) COMMUNICATION TERMINAL

(71) Applicant: Panasonic Intellectual Property Management Co., Ltd., Osaka (JP)

(72) Inventor: Taichi HAMABE, Kanagawa (JP)

(21) Appl. No.: 17/217,314

(22) Filed: Mar. 30, 2021

(30) Foreign Application Priority Data
Mar. 31, 2020 (JP) 2020-064358

(51) Int. Cl. H01Q 9/04; H01Q 13/08; H01Q 1/42

(52) U.S. Cl. CPC H01Q 9/0421; H01Q 1/42; H01Q 13/085; H01Q 9/0442

(57) ABSTRACT

A communication terminal includes a housing; an antenna substrate that is formed in a substantially rectangular shape; an antenna conductor arranged on the antenna substrate; and an antenna surrounding portion made of metal, the antenna surrounding portion being arranged in the housing and surrounding the antenna substrate.

### BACKGROUND

### 1. Technical Field

The present disclosure relates to a communication terminal capable of wireless communication.

### 2. Description of the Related Art

WO 2019/132034 A discloses an antenna device including an antenna surface provided with patches, a ground surface opposed to the antenna surface and provided with a ground conductor, and a stub in which a plurality of transmission lines having different line widths and the same line length are connected to each other in series. The stub is located in approximately the same plane as the antenna surface or between the antenna surface and the ground surface. Thus, it is possible to widen the communication frequency range and increase the antenna gain by decreasing the Q value indicating the sharpness of a peak of a resonance frequency characteristic without increasing the overall thickness of the antenna device itself.

### SUMMARY

The present disclosure has been devised in view of the conventional circumstances described above, and an object is to provide a communication terminal that stabilizes and increases the antenna gain in a desired direction in the communication frequency band regardless of the influence of metal objects existing around the arrangement space of an antenna substrate.

The present disclosure provides a communication terminal including a housing, an antenna substrate formed in a substantially rectangular shape, an antenna conductor arranged on the antenna substrate, and an antenna surrounding portion made of metal surrounding the antenna substrate.

According to the present disclosure, in the communication terminal, it is possible to stabilize and increase the antenna gain in a desired direction in the communication frequency band regardless of the influence of metal objects existing around the arrangement space of the antenna substrate.

### BRIEF DESCRIPTION OF THE DRAWINGS

FIG. 1 is a cross-sectional view showing a stack structure of a patch antenna mounted in a communication terminal according to a first exemplary embodiment;

FIG. 2 is a perspective view showing an antenna surface;

FIG. 3 is a perspective view showing a power supply surface;

FIG. 4A is a plan view of a first antenna substrate;

FIG. 4B is a graph showing an example of radiation characteristics of horizontally polarized waves from the first antenna substrate;

FIG. 4C is a graph showing an example of radiation characteristics of vertically polarized waves from the first antenna substrate;

FIG. 5A is a rear plan view of an embedded housing in which the first antenna substrate is housed;

FIG. 5B is a rear plan view schematically showing an arrangement position of the embedded housing;

FIG. 5C is a perspective view schematically showing an arrangement position of the embedded housing;

FIG. 6A is a graph showing an example of radiation characteristics of horizontally polarized waves from the first antenna substrate corresponding to FIG. 5A;

FIG. 6B is a graph showing an example of radiation characteristics of vertically polarized waves from the first antenna substrate corresponding to FIG. 5A;

FIG. 7A is a rear plan view of a rear cover screwed to the rear surface of the embedded housing of FIG. 5A;

FIG. 7B is a graph showing an example of radiation characteristics of horizontally polarized waves from the first antenna substrate corresponding to FIG. 7A;

FIG. 7C is a graph showing an example of radiation characteristics of vertically polarized waves from the first antenna substrate corresponding to FIG. 7A;

FIG. 8A is a plan view of a second antenna substrate;

FIG. 8B is a graph showing an example of radiation characteristics of horizontally polarized waves from the second antenna substrate;

FIG. 8C is a graph showing an example of radiation characteristics of vertically polarized waves from the second antenna substrate;

FIG. 9A is a rear plan view of an embedded housing in which the second antenna substrate is housed;

FIG. 9B is a graph showing an example of radiation characteristics of horizontally polarized waves from the second antenna substrate corresponding to FIG. 9A;

FIG. 9C is a graph showing an example of radiation characteristics of vertically polarized waves from the second antenna substrate corresponding to FIG. 9A;

FIG. 10A is a graph showing an example of peak gain characteristics for each communication frequency of the horizontally polarized waves from the antenna substrates corresponding to each of FIGS. 5A, 7A, and 9A; and

FIG. 10B is a graph showing an example of peak gain characteristics for each communication frequency of the vertically polarized waves from the antenna substrates corresponding to each of FIGS. 5A, 7A, and 9A.

### DETAILED DESCRIPTION

(Circumstance that Leads to the Present Disclosure)

The conventional patch antenna disclosed in WO 2019/132034 A is finally housed in the housing of a communication terminal capable of wireless communication (for example, Bluetooth (registered trademark) or wireless local area network (LAN) such as Wi-Fi (registered trademark)). When a metal object in the housing exists around the arrangement space of the patch antenna, the patch antenna is affected by the metal object and the gain characteristics deteriorate. WO 2019/132034 A does not consider technical measures in view of the deterioration of the gain characteristics after the patch antenna is finally installed in the communication terminal. In addition, the above-mentioned communication terminal may be used in a closed space such as an aircraft, but in the closed space, radio waves are likely to be reflected and the radio waves are likely to become pitching waves. It is considered desirable that not only the gain characteristics of horizontally polarized waves, but also the gain characteristics of vertically polarized waves are high. In particular, since there may be a user (for example, a passenger in an aircraft) in front of the communication terminal, it is also considered that a contribution will be made to improvement of usability when the gain characteristics of horizontally polarized waves and vertically polarized waves in the direction of the user as seen from the communication terminal are high and stabilized.

Therefore, in the exemplary embodiment below, an example of a communication terminal that stabilizes and increases the antenna gain in a desired direction in the communication frequency band regardless of the influence of metal objects existing around the arrangement space of the antenna substrate is described.

The exemplary embodiment that specifically discloses the communication terminal of the present disclosure is described in detail below with reference to the drawings properly. However, a detailed description more than necessary may be omitted. For example, a detailed description of a well-known matter and a redundant description regarding the substantially same configuration may be omitted. The reason for this is to avoid unnecessary redundancy of the following description and to help a person of ordinary skill in the art to achieve easy understanding. Note that the attached drawings and the following description are provided for those skilled in the art to fully understand the present disclosure, and are not intended to limit the subject matter as described in the appended claims.

### First Exemplary Embodiment

As a communication terminal according to the first exemplary embodiment, for example, a seat monitor provided on the rear surface side of a seat arranged in a closed space such as an aircraft is described, and a patch antenna (in other words, a microstrip antenna (MSA)) is given as an example of an antenna mounted in the communication terminal. However, the communication terminal may not be limited to the seat monitor described above as long as it is arranged in a closed space.

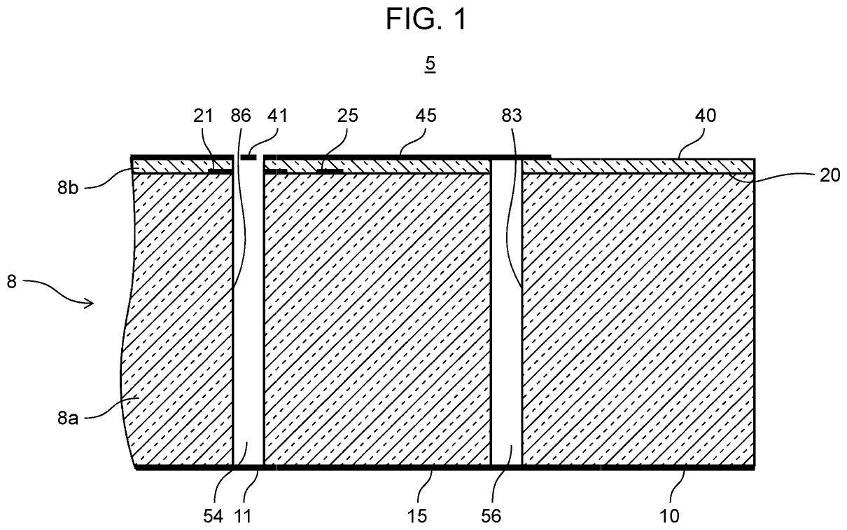

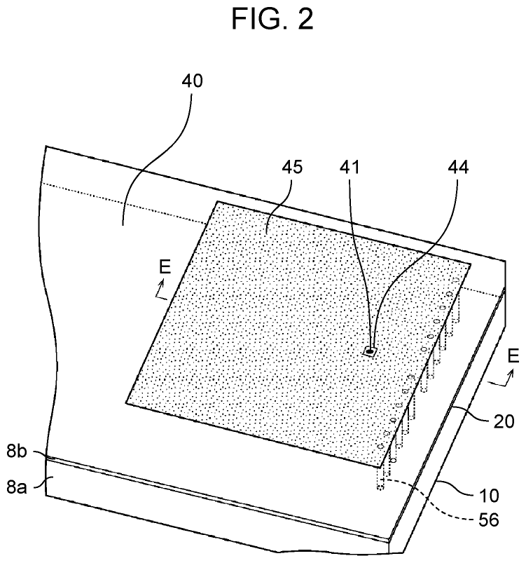

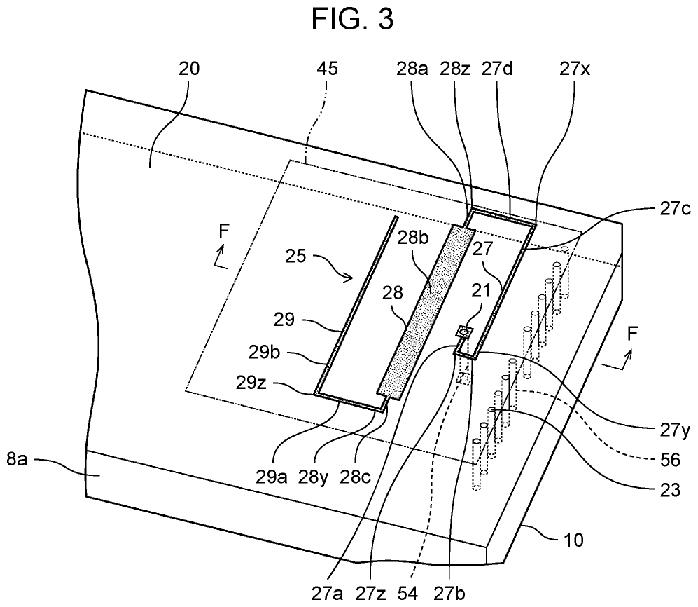

FIG. 1 is a cross-sectional view showing a stack structure of patch antenna 5 mounted in communication terminal 1 according to the first exemplary embodiment. FIG. 1 shows a cross section seen from the direction of the arrow E-E in FIG. 2 and the direction of the arrow F-F in FIG. 3. Patch antenna 5 has substrate 8 having a three-layer structure in which ground surface 10, which is a lower layer, power supply surface 20, which is an intermediate layer, and antenna surface 40, which is an upper layer, are stacked. Patch antenna 5 radiates (transmits) radio waves (radio signals) in the 2.4 GHz band represented by, for example, Bluetooth (registered trademark). Note that patch antenna 5 may radiate (transmit) not only radio waves (radio signals) in the 2.4 GHz band, but also radio waves (radio signals) in the 5 GHz band represented by, for example, wireless LAN.

Substrate 8 is a dielectric substrate formed of a dielectric having a high relative permittivity such as polyphenylene oxide (PPO), and has a multilayer structure in which substrate 8a and substrate 8b are stacked. Ground surface 10 is provided on the back surface (rear surface) of substrate 8a. Antenna surface 40 is provided on the front surface of substrate 8b. Power supply surface 20 is provided between the front surface of substrate 8a and the back surface of substrate 8b. Therefore, in patch antenna 5 according to the first exemplary embodiment, antenna surface 40 is supplied with power by the bottom excitation from power supply surface 20. The overall thickness of substrate 8 is, for example, 3 mm, the thickness of substrate 8a is 2.9 mm, and the thickness of substrate 8b is 0.1 mm. In addition, a wireless communication circuit (not shown) for supplying power to patch antenna 5 is provided on the back side of substrate 8 (i.e., the back surface side of ground surface 10).

Via conductors 54, 56 are respectively provided in through-holes 86, 83 penetrating from the front surface (i.e., antenna surface 40) to the back surface (i.e., ground surface 10) of substrate 8. Via conductors 54, 56 are formed in a cylindrical shape by filling through-holes 86, 83 with a conductive material. Via conductor 54 is a single conductor that conducts contact 41 formed on antenna surface 40 (i.e., the upper end surface of via conductor 54), power supply point 21 formed on power supply surface 20 (i.e., an intermediate cross section of via conductor 54), and contact 11 formed on ground surface 10 (i.e., the lower end surface of via conductor 54). Via conductor 54 is a power supply conductor for driving antenna surface 40 as a patch antenna. Contact 11 is connected to a power supply terminal (not shown) of a wireless communication circuit (not shown) arranged on the back surface side of substrate 8.

Via conductor 56 is a conductor that conducts patch 45 (an example of an antenna conductor) formed on antenna surface 40 and ground conductor 15 provided on ground surface 10. A plurality of via conductors 56 is provided at equal intervals in a row (see FIG. 2). Via conductors 56 are inserted so as not to be conducted in power supply surface 20. A plurality of through-holes 83 formed in power supply surface 20 are so-called through-holes.

FIG. 2 is a perspective view showing antenna surface 40. On antenna surface 40, for example, patch 45 as an example of an antenna conductor for the 2.4 GHz band is provided. Patch 45 is made of a copper foil having a rectangular shape. Opening 44 is formed in one point of the surface of patch 45, and contact 41 (i.e., the end surface of via conductor 54) is exposed at the center of opening 44. In other words, patch 45 and contact 41 are not conducted or short-circuited. Patch 45 has the characteristics of a parallel resonant circuit and radiates (transmits) radio waves (radio signals) in the 2.4 GHz band according to an excitation signal supplied to power supply point 21 of stub 25 from a wireless communication circuit (not shown). Note that patch 45 and contact 41 may be conducted (i.e., short-circuited).

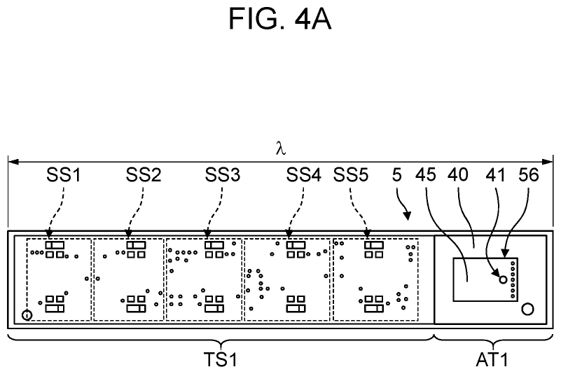

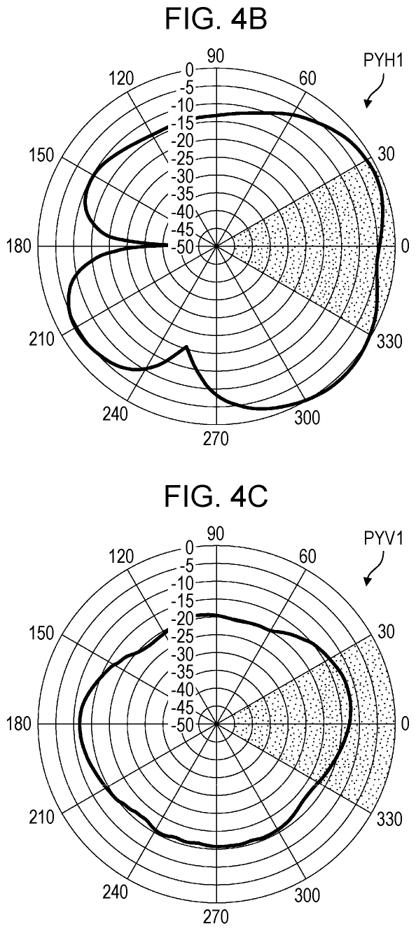

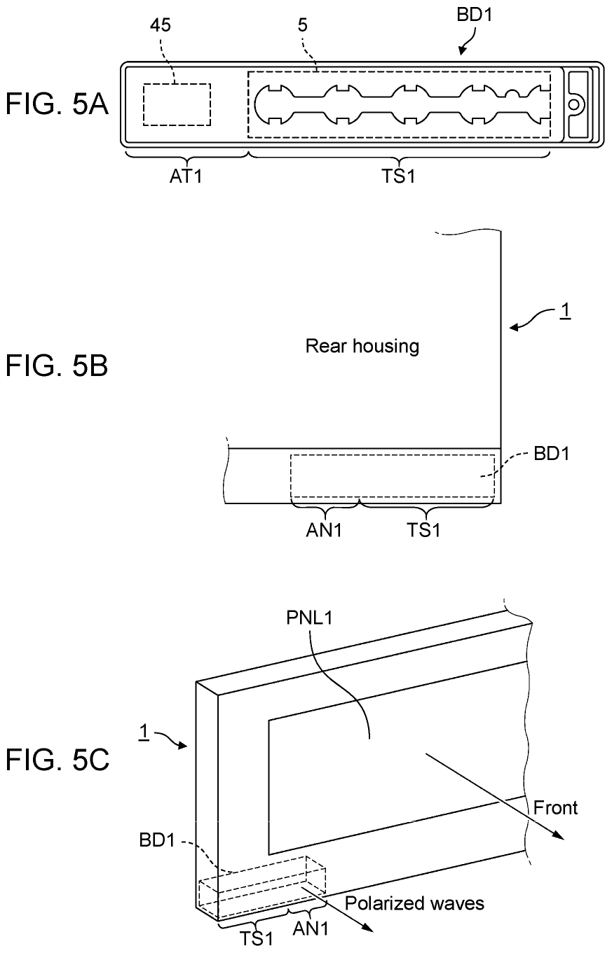

By forming patch 45 in a rectangular shape, patch antenna 5 is arranged so that the longitudinal direction of patch 45 is parallel to the longitudinal direction of communication terminal 1 when mounted in communication terminal 1 such as a seat monitor (see FIGS. 5B and 5C). When the communication frequency (in other words, wavelength λ) is set according to the length of patch antenna 5 in the longitudinal direction, the horizontally polarized radio waves are relatively strongly radiated with respect to the vertically polarized radio waves (see FIGS. 4B and 4C). Wavelength λ is the length of the wavelength corresponding to the resonance frequency of patch antenna 5.

FIG. 3 is a perspective view showing power supply surface 20. Power supply surface 20 is provided with stub 25, which is an example of a power supply line. Stub 25 has the characteristics of a series resonant circuit connected in series with patch 45 in order to achieve impedance matching of patch antenna 5 suitable for the communication frequency band in which patch antenna 5 operates (i.e., impedance matching). That is, stub 25 can bring the radiation reactance component of patch antenna 5 close to zero by electrically coupling with patch 45 in series.

Stub 25 has a shape in which power supply point 21, first transmission line 27, second transmission line 28, and third transmission line 29 are connected in series. The lengths of first transmission line 27, second transmission line 28, and third transmission line 29 are all λ/4, and the overall length of stub 25 is 3λ/4. The lengths (line lengths) of first transmission line 27, second transmission line 28, and third transmission line 29 may not be the same.

First transmission line 27 starts from power supply point 21 and has four lines 27a, 27b, 27c, 27d that are bent at substantially right angles or at right angles at three folding portions 27z, 27y, 27x. Four lines 27a to 27d have the same line width.

Second transmission line 28 has three lines 28a, 28b, 28c that are bent at substantially right angles or at right angles at two folding portions 28z, 28y, and includes line 28b having a straight shape and a larger line width as compared with first transmission line 27 and third transmission line 29. Two lines 28a, 28c and four lines 27a to 27d have the same line width.

Third transmission line 29 has a terminal end and has two lines 29a, 29b that are bent at substantially right angles or at right angles at one folding portion 29z. Two lines 29a, 29b have the same line width.

Note that first transmission line 27 may further have line 28a including folding portion 28z in addition to four lines 27a to 27d. Similarly, third transmission line 29 may further have line 28c including folding portion 28y in addition to two lines 29a, 29b. In this case, stub 25 includes three transmission lines having different line widths and the same line length. The line lengths may not be the same.

Ground conductor 15 is formed on ground surface 10 (see FIG. 1). Ground conductor 15 is made of a copper foil and is formed in a rectangular shape over substantially the entire back surface of substrate 8. The length of the entire circumference of ground conductor 15 is set to be longer by several wavelengths than the length of the entire circumference of patch 45. When the entire circumference of ground conductor 15 is longer, patch 45 is likely to resonate, and the length of the entire circumference of patch 45 can be longer according to ground conductor 15.

Next, the antenna characteristics (performance) of patch antenna 5 according to the first exemplary embodiment will be described.

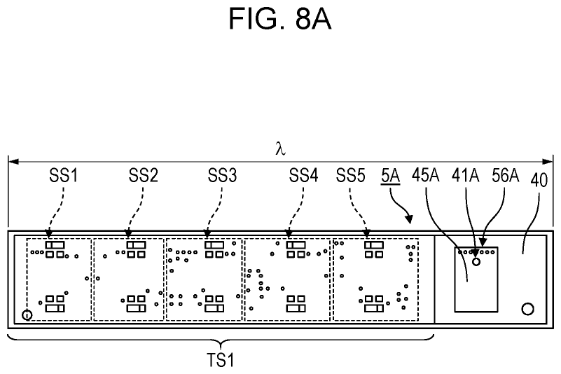

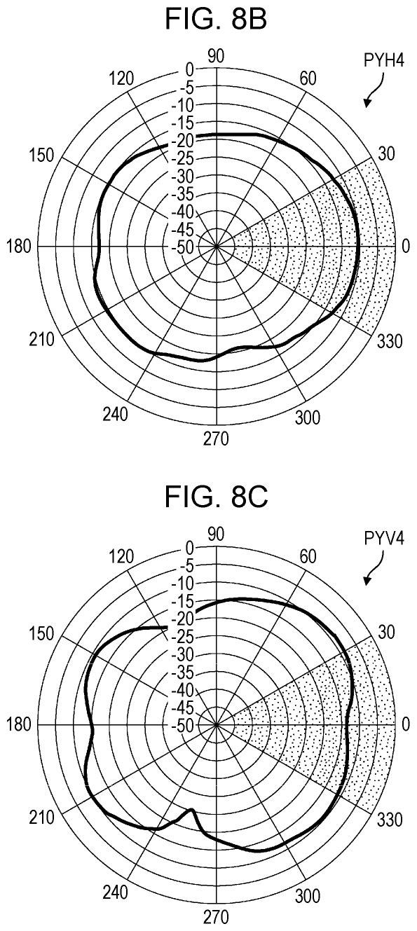

Here, as a configuration example of patch antenna 5, a first pattern (see FIG. 4A) in which the longitudinal direction of patch 45 having a rectangular shape is parallel to the longitudinal direction of an antenna substrate having a rectangular shape (see below) and a second pattern (see FIG. 8A) in which the direction orthogonal to the longitudinal direction of patch 45 is parallel to the longitudinal direction of an antenna substrate (see below) will be described as an example.

### [Antenna Substrate of the First Pattern]

FIG. 4A is a plan view of first antenna substrate 5A. FIG. 4B is a graph showing an example of radiation characteristics PYH1 of horizontally polarized waves from first antenna substrate 5A. FIG. 4C is a graph showing an example of radiation characteristics PYV1 of vertically polarized waves from first antenna substrate 5A. In the description of FIG. 4A, the same configurations as those shown in FIGS. 1 to 3 are given the same reference numerals and description will be simplified or omitted, and different contents will be described.

First antenna substrate 5A is a specific example of realizing patch antenna 5 of FIG. 1. On first antenna substrate 5A, in addition to antenna portion AT1 constituting patch antenna 5, touch sensor portion TS1 having a plurality of touch sensors SS1, SS2, SS3, SS4, SS5 is further arranged. Note that, needless to say, the number of touch sensors arranged is not limited to five. As a result, first antenna substrate 5A can secure a ground length in which not only antenna portion AT1 but also touch sensor portion TS1 can be arranged, and patch 45 can easily resonate and a reduction in antenna gain can be suppressed.

First antenna substrate 5A is formed in a rectangular shape, and the length in the longitudinal direction matches wavelength λ (one wavelength) of the radio waves radiated from first antenna substrate 5A. Wavelength λ is, for example, 125 mm. On the other hand, the length of first antenna substrate 5A in the width direction (that is, the direction orthogonal to the longitudinal direction) is sufficiently shorter than λ. As a result, even when the antenna substrate is arranged in embedded housing BD1 described later, it is possible to radiate polarized waves with high gain without being affected by surrounding metal objects.

In addition, since the longitudinal direction of first antenna substrate 5A and the longitudinal direction of patch 45 having a rectangular shape are the same direction (in other words, parallel), the longitudinal direction of ground surface 10 corresponding to the longitudinal direction (in other words, a length direction) of patch 45 and the longitudinal direction of first antenna substrate 5A are the same direction, and patch 45 of antenna surface 40 and stub 25 of power supply surface 20 can be easily electromagnetically coupled. As a result, as shown in FIGS. 4B and 4C, horizontally polarized waves are more likely to be strongly radiated from first antenna substrate 5A than vertically polarized waves. That is, it can be said that the radiated horizontally polarized waves of first antenna substrate 5A alone stably transition with a high gain in a desired direction (see below).

In FIGS. 4B and 4C, the direction of about 60 degrees from 330 degrees to 30 degrees is, for example, the direction in which a user (for example, an aircraft passenger) is present in front of communication terminal 1 in which first antenna substrate 5A is mounted, and indicates a desired direction in which high gain characteristics are desired for radio waves first antenna substrate 5A radiates. However, as shown in FIG. 4C, first antenna substrate 5A alone (in other words, the state where first antenna substrate 5A is not mounted in communication terminal 1) does not provide high gain characteristics of vertically polarized waves, and it is difficult to say that the vertically polarized waves are stable because the gain does not transition uniformly in the desired direction (see above).

FIG. 5A is a rear plan view of embedded housing BD1 in which first antenna substrate 5A is housed. FIG. 5B is a rear plan view schematically showing an arrangement position of embedded housing BD1. FIG. 5C is a perspective view schematically showing an arrangement position of embedded housing BD1. In the description of FIGS. 5A to 5C, the same configurations as those shown in FIGS. 1 to 3 or FIG. 4A are given the same reference numerals and description will be simplified or omitted, and different contents will be described.

Embedded housing BD1 is formed of, for example, a lightweight metal (e.g., aluminum) and has a housing space that can surround first antenna substrate 5A. In other words, since first antenna substrate 5A is, when finally mounted in communication terminal 1, arranged in the housing space of embedded housing BD1, first antenna substrate 5A is surrounded by metal objects (e.g., aluminum) forming embedded housing BD1 when communication terminal 1 is used. The antenna surrounding portion (for example, embedded housing BD1) is formed along the antenna substrate (for example, first antenna substrate 5A) in order to surround the antenna substrate (for example, first antenna substrate 5A). In addition, the antenna surrounding portion (for example, embedded housing BD1) is formed in a rectangular shape in the same direction as the antenna substrate (for example, first antenna substrate 5A). In FIG. 5A, first antenna substrate 5A is arranged in the housing space of embedded housing BD1 in a state where the orientation of first antenna substrate 5A is flipped horizontally with respect to the orientation of FIG. 4A. That is, in FIGS. 5A and 4A, antenna portion AT1 and touch sensor portion TS1 are shown flipped horizontally.

As shown in FIG. 5B, embedded housing BD1 is arranged and incorporated on one end side (for example, a lower end side) of the back surface (rear housing) of a metal housing (for example, main housing MBD1) of communication terminal 1 such as a seat monitor. Note that the arrangement position of embedded housing BD1 may not be limited to the lower end side of the rear surface of main housing MBD1 shown in FIG. 5B. That is, in communication terminal 1, the arrangement space of patch antenna 5 (i.e., first antenna substrate 5A) is limited. As shown in FIG. 5C, first antenna substrate 5A arranged in embedded housing BD1 radiates horizontally polarized waves or vertically polarized waves in the direction of the user from the front surface side (in other words, the front side seen by the user) where display panel PNL1 of communication terminal 1 is provided.

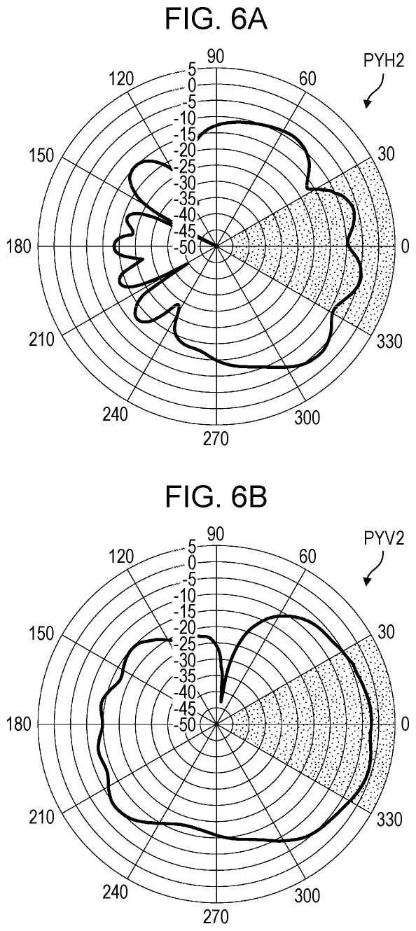

FIG. 6A is a graph showing an example of radiation characteristics PYH2 of horizontally polarized waves from first antenna substrate 5A corresponding to FIG. 5A. FIG. 6B is a graph showing an example of radiation characteristics PYV2 of vertically polarized waves from first antenna substrate 5A corresponding to FIG. 5A.

As shown in FIG. 6A, the horizontally polarized waves are affected by surrounding metal objects when first antenna substrate 5A is arranged in embedded housing BD1 as compared with the case where first antenna substrate 5A is provided alone. Therefore, although a constant antenna gain suitable for wireless communication by horizontally polarized waves can be obtained, the gain characteristics in the desired direction are deteriorated, for example, electric field nodes are generated in the directions of 30 degrees and 330 degrees.

However, as shown in FIG. 6B, it can be seen that the vertically polarized waves stably transition with high gain in the desired direction when first antenna substrate 5A is arranged in embedded housing BD1 as compared with the case where first antenna substrate 5A is provided alone. This is because when first antenna substrate 5A is arranged and surrounded in embedded housing BD1, first antenna substrate 5A having a length of λ serves as an excitation source and a pitching secondary resonance occurs in embedded housing BD1, and the characteristics of vertically polarized waves with a considerably high gain exceeding the deterioration of the characteristics by the influence of surrounding metal objects can be obtained. Therefore, with communication terminal 1, the horizontally polarized waves having the characteristics shown in FIG. 6A can be radiated, but the vertically polarized waves radiated from communication terminal 1 can be radiated in the direction of the user (for example, from 330 degrees to 30 degrees inclusive) with high gain. Thus, it is possible to improve the convenience (that is, usability) of the user who uses communication terminal 1.

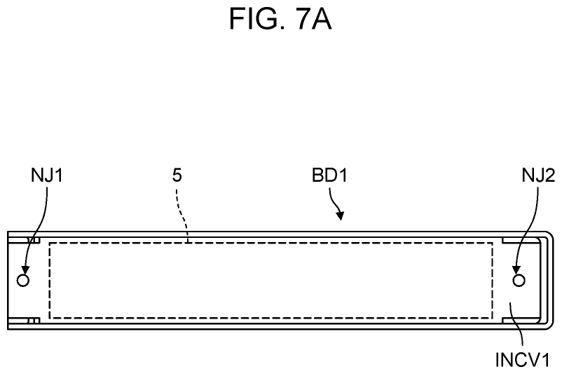

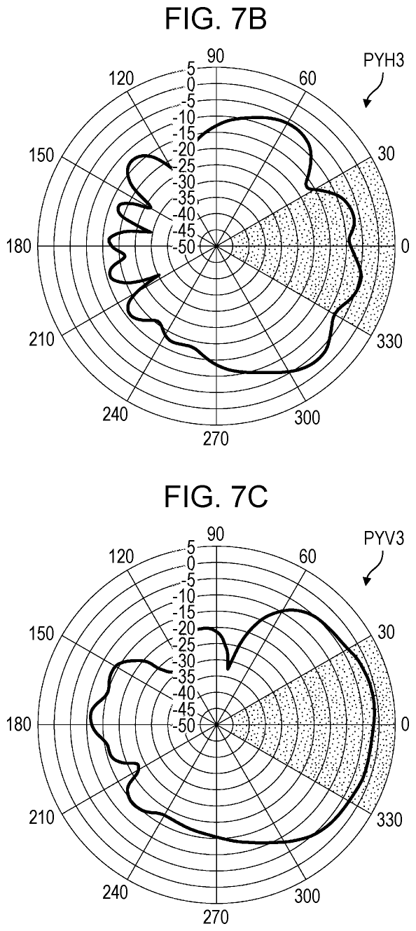

FIG. 7A is a rear plan view of rear cover INCV1 screwed to the rear surface of embedded housing BD1 of FIG. 5A. FIG. 7B is a graph showing an example of radiation characteristics PYH3 of horizontally polarized waves from first antenna substrate 5A corresponding to FIG. 7A. FIG. 7C is a graph showing an example of radiation characteristics PYV3 of vertically polarized waves from first antenna substrate 5A corresponding to FIG. 7A. In the description of FIG. 7A, the same configurations as those shown in FIG. 5A are given the same reference numerals and description will be simplified or omitted, and different contents will be described.

As shown in FIG. 7A, on the rear surface of main housing MBD1 of communication terminal 1, rear cover INCV1 is screwed on the rear surface side of embedded housing BD1 by two screws NJ1, NJ2 to surround first antenna substrate 5A. As a result, first antenna substrate 5A can be arranged by being surrounded by embedded housing BD1 and rear cover INCV1 almost omnidirectionally. Therefore, as described above, when first antenna substrate 5A having a length of λ serves as an excitation source and a pitching secondary resonance is more likely to occur in embedded housing BD1 and rear cover INCV1, the characteristics of vertically polarized waves with higher gain are obtained (see FIG. 7C). Regarding the horizontally polarized waves, there is no significant difference in characteristics between the case where rear cover INCV1 is provided (see FIG. 7A) and the case where rear cover INCV1 is not provided (see FIG. 5A).

### [Antenna Substrate of the Second Pattern]

FIG. 8A is a plan view of second antenna substrate 5B. FIG. 8B is a graph showing an example of radiation characteristics PYH4 of horizontally polarized waves from second antenna substrate 5B. FIG. 8C is a graph showing an example of radiation characteristics PYV4 of vertically polarized waves from second antenna substrate 5B. In the description of FIG. 8A, the same configurations as those shown in FIGS. 1 to 3 are given the same reference numerals and description will be simplified or omitted, and different contents will be described.

Second antenna substrate 5B is a specific example of realizing patch antenna 5 of FIG. 1. On second antenna substrate 5B, in addition to antenna portion AT2 constituting patch antenna 5, touch sensor portion TS1 having a plurality of touch sensors SS1 to SS5 is further arranged. The configuration of antenna portion AT2 is the same as the configuration of antenna portion AT1 including the cross-sectional structure (see FIG. 1) including antenna surface 40 provided with patch 45A, power supply surface 20, and ground surface 10, except that antenna portion AT1 (see FIG. 4A) is rotated 90 degrees counterclockwise in a plan view. Therefore, detailed description will be omitted. For example, in antenna portion AT2, each of a plurality of via conductors 56A is provided in the same direction as the longitudinal direction of second antenna substrate 5B, and contact 41A is also arranged so as to face via conductors 56A (FIGS. 2 and 8A). Note that, needless to say, the number of touch sensors arranged is not limited to five. As a result, second antenna substrate 5B can secure a ground length in which not only antenna portion AT2 but also touch sensor portion TS1 can be arranged, and patch 45A can easily resonate and a reduction in antenna gain can be suppressed.

Second antenna substrate 5B is formed in a rectangular shape, and the length in the longitudinal direction is longer than wavelength λ (one wavelength) of the radio wave radiated from second antenna substrate 5B, for example, 150 mm. On the other hand, the length of second antenna substrate 5B in the width direction (that is, the direction orthogonal to the longitudinal direction) is sufficiently shorter than λ. As a result, even when the antenna substrate is arranged in embedded housing BD1 described later, it is possible to radiate polarized waves with high gain without being affected by surrounding metal objects.

In addition, since the longitudinal direction of second antenna substrate 5B and the direction orthogonal to the longitudinal direction of patch 45A having a rectangular shape are the same direction (in other words, parallel), the electromagnetic coupling between patch 45A of antenna surface 40 and stub 25 of power supply surface 20 is not strong as compared with first antenna substrate 5A alone. Therefore, as shown in FIG. 8B, the radiation characteristics of the horizontally polarized waves from second antenna substrate 5B are deteriorated as compared with those of first antenna substrate 5A. However, since the longitudinal direction of second antenna substrate 5B and the length direction of patch 45A are perpendicular to each other, as shown in FIG. 8C, the radiation characteristics of the vertically polarized waves from second antenna substrate 5B are considerably improved as compared with those of first antenna substrate 5A.

In FIGS. 8B and 8C, the direction of about 60 degrees from 330 degrees to 30 degrees is, for example, the direction in which a user (for example, an aircraft passenger) is present in front of communication terminal 1 in which second antenna substrate 5B is mounted, and indicates a desired direction in which high gain characteristics are desired for radio waves second antenna substrate 5B radiates. However, as shown in FIGS. 8B and 8C, second antenna substrate 5B alone (in other words, the state where second antenna substrate 5B is not mounted in communication terminal 1) provides high gain characteristics of vertically polarized waves as compared with first antenna substrate 5A alone, but it is difficult to say that the vertically polarized waves are stable because the gain does not transition uniformly in the desired direction (see above).

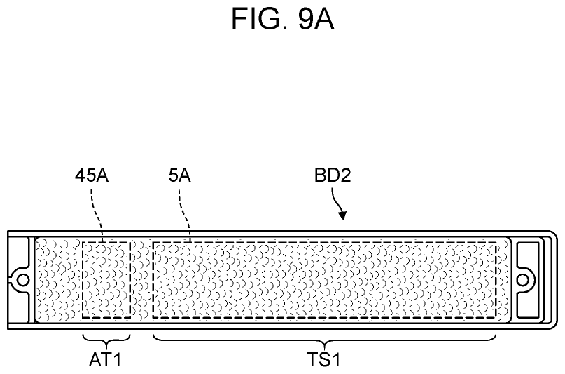

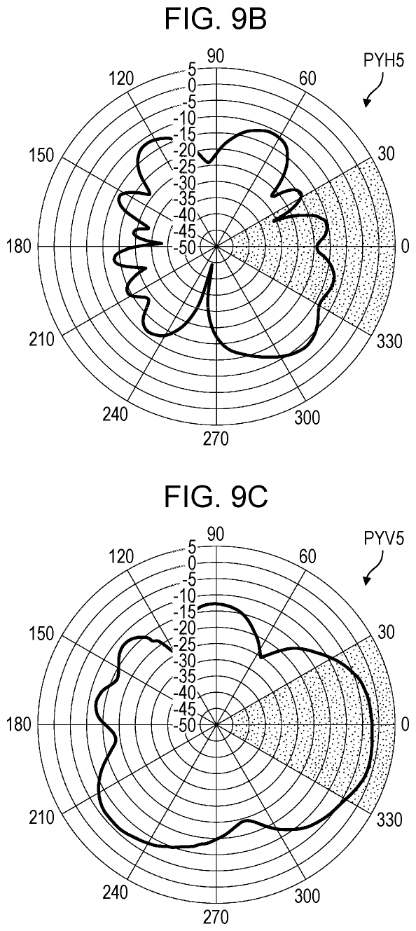

FIG. 9A is a rear plan view of embedded housing BD2 in which second antenna substrate 5B is housed. FIG. 9B is a graph showing an example of radiation characteristics PYH5 of horizontally polarized waves from second antenna substrate 5B corresponding to FIG. 9A. FIG. 9C is a graph showing an example of radiation characteristics PYV5 of vertically polarized waves from second antenna substrate 5B corresponding to FIG. 9A. In the description of FIG. 9A, the same configurations as those shown in FIG. 7A or 8A are given the same reference numerals and description will be simplified or omitted, and different contents will be described.

Embedded housing BD2 is formed of, for example, a lightweight metal (e.g., aluminum) and has a housing space that can surround second antenna substrate 5B. In other words, since second antenna substrate 5B is, when finally mounted in communication terminal 1, arranged in the housing space of embedded housing BD2, second antenna substrate 5B is surrounded by metal objects (e.g., aluminum) forming embedded housing BD2 when communication terminal 1 is used. In FIG. 9A, second antenna substrate 5B is arranged in the housing space of embedded housing BD2 in a state where the orientation of second antenna substrate 5B is flipped horizontally with respect to the orientation of FIG. 8A. That is, in FIGS. 9A and 8A, antenna portion AT2 and touch sensor portion TS1 are shown flipped horizontally.

As shown in FIG. 9B, the horizontally polarized waves are affected by surrounding metal objects when second antenna substrate 5B is arranged in embedded housing BD2 as compared with the case where second antenna substrate 5B is provided alone. Therefore, although a constant antenna gain suitable for wireless communication by horizontally polarized waves can be obtained, the gain characteristics in the desired direction are deteriorated, for example, electric field nodes are generated in the directions of 30 degrees and 330 degrees.

However, as shown in FIG. 9C, it can be seen that the vertically polarized waves stably transition with high gain in the desired direction when second antenna substrate 5B is arranged in embedded housing BD2 as compared with the case where second antenna substrate 5B is provided alone. This is because when second antenna substrate 5B is arranged and surrounded in embedded housing BD2, second antenna substrate 5B serves as an excitation source and a pitching secondary resonance occurs in embedded housing BD2, and the characteristics of vertically polarized waves with a considerably high gain exceeding the deterioration of the characteristics by the influence of surrounding metal objects can be obtained. Therefore, with communication terminal 1, the horizontally polarized waves having the characteristics shown in FIG. 9B can be radiated, but the vertically polarized waves radiated from communication terminal 1 can be radiated in the direction of the user (for example, from 330 degrees to 30 degrees inclusive) with high gain. Thus, it is possible to improve the convenience (that is, usability) of the user who uses communication terminal 1.

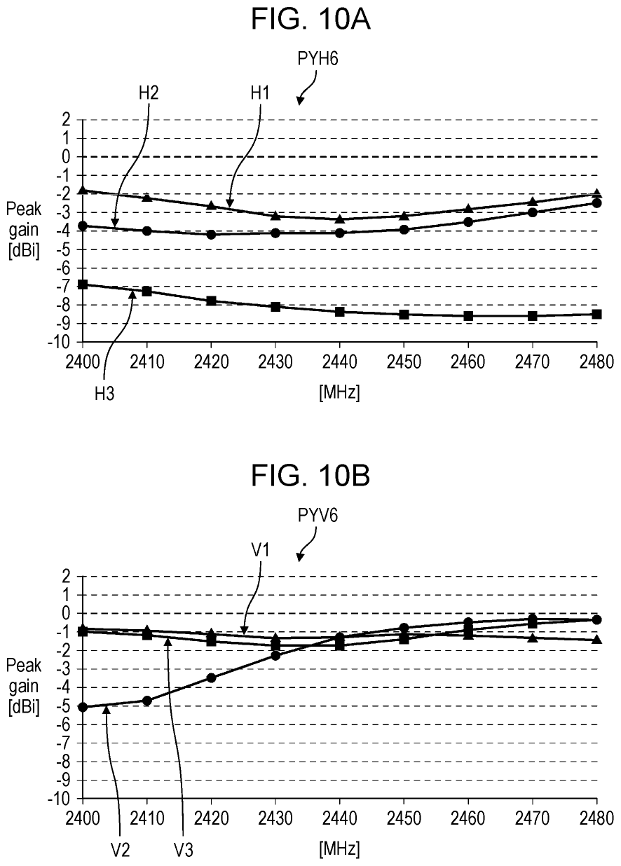

FIG. 10A is a graph showing an example of peak gain characteristics for each communication frequency of the horizontally polarized waves from the antenna substrates corresponding to each of FIGS. 5A, 7A, and 9A; and FIG. 10B is a graph showing an example of peak gain characteristics for each communication frequency of the vertically polarized waves from the antenna substrates corresponding to each of FIGS. 5A, 7A, and 9A.

In FIG. 10A, characteristic H1 shows peak gain characteristics for each communication frequency of the horizontally polarized waves corresponding to first antenna substrate 5A housed in embedded housing BD1 and rear cover INCV1. Characteristic H2 shows peak gain characteristics for each communication frequency of the horizontally polarized waves corresponding to first antenna substrate 5A housed in embedded housing BD1. Characteristic H3 shows peak gain characteristics for each communication frequency of the horizontally polarized waves corresponding to second antenna substrate 5B housed in embedded housing BD2.

According to FIG. 10A, first antenna substrate 5A surrounded by both embedded housing BD1 and rear cover INCV1 (that is, further omnidirectionally surrounded) has the highest peak gain characteristics and stability in the communication frequency band. This is because the environment in which first antenna substrate 5A having a length of wavelength λ is likely to cause secondary resonance (see above) in embedded housing BD1 and rear cover INCV1 is realized. In addition, even when rear cover INCV1 is not provided, a high gain and a stable peak gain are obtained from first antenna substrate 5A arranged in embedded housing BD1. On the other hand, even when second antenna substrate 5B is arranged in embedded housing BD2, second antenna substrate 5B does not provide the high gain characteristics of first antenna substrate 5A. It is considered that this is because the resonance intensity of second antenna substrate 5B is weaker than that of first antenna substrate 5A because the longitudinal direction and the length direction of patch 45A are not parallel but perpendicular.

In FIG. 10B, characteristic V1 shows peak gain characteristics for each communication frequency of the vertically polarized waves corresponding to first antenna substrate 5A housed in embedded housing BD1 and rear cover INCV1. Characteristic V2 shows peak gain characteristics for each communication frequency of the vertically polarized waves corresponding to first antenna substrate 5A housed in embedded housing BD1. Characteristic V3 shows peak gain characteristics for each communication frequency of the vertically polarized waves corresponding to second antenna substrate 5B housed in embedded housing BD2.

In addition, according to FIG. 10B, first antenna substrate 5A surrounded by both embedded housing BD1 and rear cover INCV1 (that is, further omnidirectionally surrounded) has the highest peak gain characteristics and stability in the communication frequency band. This is because, similar to the case of the horizontally polarized waves, the environment in which first antenna substrate 5A having a length of wavelength λ is likely to cause secondary resonance (see above) in embedded housing BD1 and rear cover INCV1 is realized. In addition, even when rear cover INCV1 is not provided, a high peak gain is obtained in the communication frequency band from first antenna substrate 5A arranged in embedded housing BD1. Since second antenna substrate 5B is arranged in embedded housing BD2, second antenna substrate 5B provides the high gain characteristics of first antenna substrate 5A.

As described above, communication terminal 1 according to the first exemplary embodiment includes main housing MBD1, an antenna substrate (for example, first antenna substrate 5A) formed in a substantially rectangular shape and on which an antenna conductor (for example, patch 45) is arranged, and an antenna surrounding portion (for example, embedded housing BD1) made of metal that surrounds the antenna substrate.

As a result, with communication terminal 1, it is possible to stabilize and increase the antenna gain in the desired direction (e.g., in the direction of the user) in the communication frequency band in which the antenna operates regardless of the influence of metal objects existing around the arrangement space of the antenna substrate.

In addition, the antenna conductor (for example, patch 45) is formed in a substantially rectangular shape having long sides parallel to the longitudinal direction of the antenna substrate (for example, first antenna substrate 5A) and short sides parallel to the direction orthogonal to the longitudinal direction (see, for example, FIG. 4A). Thus, since the longitudinal direction of first antenna substrate 5A and the longitudinal direction of patch 45 having a rectangular shape are the same direction (in other words, parallel), the longitudinal direction of ground surface 10 corresponding to the longitudinal direction (in other words, a length direction) of patch 45 and the longitudinal direction of first antenna substrate 5A are the same direction, and patch 45 of antenna surface 40 and stub 25 of power supply surface 20 can be easily electromagnetically coupled. Therefore, the horizontally polarized waves are likely to be strongly radiated from first antenna substrate 5A.

In addition, the antenna conductor (for example, patch 45A) is formed in a substantially rectangular shape having short sides parallel to the longitudinal direction of the antenna substrate (for example, second antenna substrate 5B) and long sides parallel to the direction orthogonal to the longitudinal direction (see, for example, FIG. 8A). As a result, since the longitudinal direction of second antenna substrate 5B and the longitudinal direction of patch 45A having a rectangular shape are orthogonal to each other, the vertically polarized waves are likely to be strongly radiated from second antenna substrate 5B.

In addition, the antenna surrounding portion (for example, embedded housing BD1) is screwed via rear cover INCV1 arranged on the rear surface side of the main housing facing the antenna substrate. As a result, the antenna substrate can be arranged by being surrounded by embedded housing BD1 and rear cover INCV1 almost omnidirectionally. Therefore, when the antenna substrate having a length of wavelength λ serves as an excitation source and a pitching secondary resonance is more likely to occur in embedded housing BD1 and rear cover INCV1, the characteristics of vertically polarized waves with higher gain are obtained.

In addition, the length of the antenna substrate in the longitudinal direction is one wavelength of radio waves radiated from the antenna conductor. As a result, because a sufficient ground surface can be secured, the band of the antenna can be widened by electromagnetically coupling patch 45 and stub 25 corresponding to the antenna substrate (for example, first antenna substrate 5A).

In addition, the antenna substrate (for example, first antenna substrate 5A) includes antenna surface 40 provided with the antenna conductor, ground surface 10 facing antenna surface 40 and provided with ground conductor 15, and power supply surface 20 having stub 25 including a plurality of transmission lines having different line widths and connected in series. Stub 25 is located between antenna surface 40 and ground surface 10. The antenna conductor (for example, patch 45) is electrically conductive with stub 25 via power supply point 21 connected to the transmission line at one end of the plurality of transmission lines. As a result, patch antenna 5 or communication terminal 1 can increase the distance between antenna surface 40 and ground surface 10 without increasing the overall thickness of patch antenna 5 itself. Therefore, in patch antenna 5, the Q value indicating the sharpness of the peak of the resonance frequency characteristic can be reduced, that is, the Q value of the communication frequency can be reduced. In other words, the frequency band of radio wave in which patch antenna 5 can operate can be widened. In addition, by widening the bandwidth, the reflection of radio waves is reduced, and the gain of antenna (that is, the gain of communication power) can be increased.

Heretofore, the various exemplary embodiments have been described with reference to the drawings. However, needless to say, the present disclosure is not limited to the examples. It is apparent that those skilled in the art may conceive of various change examples, modification examples, replacement examples, addition examples, deletion examples, and equivalent examples within the scope of the claims, which are understood to fall within the technical scope of the present disclosure. In addition, the constituent elements of the aforementioned various exemplary embodiments may be optionally combined without departing from the gist of the present disclosure.

For example, patch antenna 5 according to the first exemplary embodiment described above has been described by exemplifying a use case applied to the antenna of a transmitting device that transmits radio waves, but it may be applied to the antenna of a receiving device that receives radio waves.

The present disclosure is useful as a communication terminal for stabilizing and increasing an antenna gain in a desired direction in a communication frequency band regardless of the influence of metal objects existing around the arrangement space of the antenna substrate.

What is claimed is:

1. A communication terminal comprising:
a housing;
an antenna substrate that is formed in a substantially rectangular shape;
an antenna conductor arranged on the antenna substrate; and
an antenna surrounding portion made of metal, the antenna surrounding portion being arranged in the housing and surrounding the antenna substrate.

2. The communication terminal according to claim 1, wherein the antenna conductor is formed in a substantially rectangular shape, and the antenna conductor has (i) long sides parallel to a longitudinal direction of the antenna substrate and (ii) short sides parallel to a direction orthogonal to the longitudinal direction.

3. The communication terminal according to claim 1, wherein the antenna conductor is formed in a substantially rectangular shape, and the antenna conductor has (i) short sides parallel to a longitudinal direction of the antenna substrate and (ii) long sides parallel to a direction orthogonal to the longitudinal direction.

4. The communication terminal according to claim 1, wherein
the housing includes a rear cover that is arranged on a rear surface side of the housing and faces the antenna substrate, and
the antenna surrounding portion is screwed via the rear cover.

5. The communication terminal according to claim 1, wherein a length of the antenna substrate in a longitudinal direction is one wavelength of radio waves radiated from the antenna conductor.

6. The communication terminal according to claim 1, wherein
the antenna substrate includes:
an antenna surface provided with the antenna conductor;
a ground surface that faces the antenna surface and is provided with a ground conductor; and
a power supply surface that has a stub including a plurality of transmission lines having different line widths and connected in series,
the stub is located between the antenna surface and the ground surface, and
the antenna conductor is electrically conductive with the stub via a power supply point connected to a transmission line at one end of the plurality of transmission lines.
